(19) United States
(12) Patent Application Publication
(10) Pub. No.: US 2026/0169266 A1
(43) Pub. Date: Jun. 18, 2026

(54) LENS ASSEMBLY

(71) Applicant: Asia Optical Co., Inc., Taichung (TW)

(72) Inventor: Po-Yuan Shih, Taichung (TW)

(21) Appl. No.: 19/316,158

(22) Filed: Sep. 2, 2025

(30) Foreign Application Priority Data
Dec. 16, 2024 (TW) 113148944

(51) Int. Cl. G02B 13/00; G02B 9/34

(52) U.S. Cl. CPC G02B 13/004; G02B 9/34

(57) ABSTRACT

A lens assembly includes a first lens, a second lens, a third lens, and a fourth lens. The first lens is with positive refractive power and includes a convex surface facing an object side. The second lens is with refractive power. The third lens is a meniscus lens with positive refractive power and includes a concave surface facing the object side and a convex surface facing an image side. The fourth lens is with negative refractive power and includes a concave surface facing the image side. The first lens, the second lens, the third lens, and the fourth lens are arranged in order from the object side to the image side along an optical axis.

### BACKGROUND OF THE INVENTION

### Field of the Invention

The invention relates to a lens assembly.

### Description of the Related Art

In current developments of imaging lenses, in addition to the continuous pursuit of higher resolution, there is an increasing demand for compact size and wide field of view due to various application requirements. Conventional imaging lenses can no longer meet these modern demands. Therefore, there is a need for a novel lens assembly architecture capable of simultaneously achieving high resolution, miniaturization, and a wide field of view.

### BRIEF SUMMARY OF THE INVENTION

The invention provides a lens assembly to solve the above problems. The lens assembly of the invention is provided with characteristics of a higher resolution, a decreased total length of the lens assembly, a wider field of view, a decreased total height of the lens assembly and still has a good optical performance.

The lens assembly in accordance with an exemplary embodiment of the invention includes a first lens, a second lens, a third lens, and a fourth lens, all of which are arranged in order from an object side to an image side along an optical axis. The first lens is with positive refractive power and includes a convex surface facing the object side. The second lens is with refractive power. The third lens is a meniscus lens with positive refractive power, and includes a concave surface facing the object side and a convex surface facing the image side. The fourth lens is with negative refractive power and includes a concave surface facing the image side. The lens assembly satisfies at least one of following conditions: 2≤TTL/BFL≤2.9; 0.2 mm≤T2+T4≤0.5 mm; 0.5≤f3/f≤0.8; −2<R12/R11<4; 1.4≤D4/f≤1.7; −3≤D4/f4≤−1; 0.3≤D1/f1≤0.6; 0.6<S4/T4<1.4; 2<D4/BFL<6; 107 degrees/mm²<FOV/(f+TTL)²<111 degrees/mm²; 92 degrees/mm<FOV/D1<107 degrees/mm; wherein TTL is an interval from an object side surface of the first lens to an image plane along the optical axis, BFL is an interval from an image side surface of the fourth lens to the image plane along the optical axis, T2 is an interval from an object side surface of the second lens to an image side surface of the second lens, T4 is an interval from an object side surface of the fourth lens to the image side surface of the fourth lens, f is an effective focal length of the lens assembly, f1 is an effective focal length of the first lens, f3 is an effective focal length of the third lens, f4 is an effective focal length of the fourth lens, R₁₁ is a radius of curvature of the object side surface of the first lens, R₁₂ is a radius of curvature of an image side surface of the first lens, D1 is an optical effective diameter of the first lens, D4 is an optical effective diameter of the fourth lens, S4 is a depth from a center point of the image side surface of the fourth lens to a vertex of the image side surface of the fourth lens along the optical axis, and FOV is a field of view of the lens assembly. The basic operation of the lens assembly in the present invention can be achieved by satisfying the features of the exemplary embodiment without requiring other conditions.

In another exemplary embodiment, the second lens is a meniscus lens with negative refractive power.

In yet another exemplary embodiment, the second lens comprises a concave surface facing the object side and a convex surface facing the image side.

In another exemplary embodiment, the first lens is a meniscus lens and further comprises a concave surface facing the image side.

In yet another exemplary embodiment, the fourth lens is a meniscus lens and further comprises a convex surface facing the object side.

In another exemplary embodiment, the lens assembly satisfies at least one of the following conditions: −180<f2/T2<−105; 40 mm<(TTL)2/(T1/2)≤45 mm; 5.5<R12/R42<7.3; 8.5 mm<(R12)2/BFL<12.5 mm; wherein f2 is an effective focal length of the second lens, T1 is an interval from the object side surface of the first lens to the image side surface of the first lens, T2 is an interval from the object side surface of the second lens to the image side surface of the second lens, TTL is an interval from the object side surface of the first lens to the image plane along the optical axis, BFL is an interval from the image side surface of the fourth lens to the image plane along the optical axis, R12 is a radius of curvature of the image side surface of the first lens, and R42 is a radius of curvature of the image side surface of the fourth lens.

In yet another exemplary embodiment, further comprising a stop disposed between the object side and the first lens; wherein the lens assembly satisfies at least one of the following conditions: 0.01≤SL/TTL≤0.06; 1<Dr12r21/T4<1.4; wherein SL is an interval from the stop to the object side surface of the first lens along the optical axis, TTL is an interval from the object side surface of the first lens to the image plane along the optical axis, Dr12r21 is an interval from the image side surface of the first lens to the object side surface of the second lens along the optical axis, and T4 is an interval from the object side surface of the fourth lens to the image side surface of the fourth lens.

In another exemplary embodiment, the second lens comprises a convex surface facing the object side and a concave surface facing the image side.

In yet another exemplary embodiment, the first lens is a biconvex lens and further comprises another convex surface facing the image side.

In another exemplary embodiment, further comprising a stop disposed between the object side and the first lens; wherein the lens assembly satisfies at least one of the following conditions: 0.01≤SL/TTL≤0.06; wherein SL is an interval from the stop to the object side surface of the first lens along the optical axis, and TTL is an interval from the object side surface of the first lens to the image plane along the optical axis.

In yet another exemplary embodiment, the lens assembly satisfies at least one of the following conditions: 0.01≤SL/TTL≤0.06; −180<f2/T2<−105; 1<Dr12r21/T4<1.4; 40 mm<(TTL)2/(T1/2)≤45 mm; 5.5<R12/R42<7.3; 8.5 mm<(R12)2/BFL<12.5 mm; wherein SL is an interval from the stop to the object side surface of the first lens along the optical axis, f2 is an effective focal length of the second lens, T1 is an interval from the object side surface of the first lens to the image side surface of the first lens, T2 is an interval from the object side surface of the second lens to the image side surface of the second lens, T4 is an interval from the object side surface of the fourth lens to the image side surface of the fourth lens, TTL is an interval from the object side surface of the first lens to the image plane along the optical axis, BFL is an interval from the image side surface of the fourth lens to the image plane along the optical axis, R₁₂ is a radius of curvature of the image side surface of the first lens, R₄₂ is a radius of curvature of the image side surface of the fourth lens, and Dr12r21 is an interval from the image side surface of the first lens to the object side surface of the second lens along the optical axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of a lens assembly in accordance with a first embodiment of the invention;

FIG. 2 depict a field curvature diagram of the lens assembly in accordance with the first embodiment of the invention;

FIG. 3 depict a distortion diagram of the lens assembly in accordance with the first embodiment of the invention;

FIG. 4 depict a lateral color diagram of the lens assembly in accordance with the first embodiment of the invention;

FIG. 5 is a lens layout diagram of a lens assembly in accordance with a second embodiment of the invention;

FIG. 6 is a lens layout diagram of a lens assembly in accordance with a third embodiment of the invention;

FIG. 7 depict a field curvature diagram of the lens assembly in accordance with the third embodiment of the invention;

FIG. 8 depict a distortion diagram of the lens assembly in accordance with the third embodiment of the invention; and

FIG. 9 depict a lateral color diagram of the lens assembly in accordance with the third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

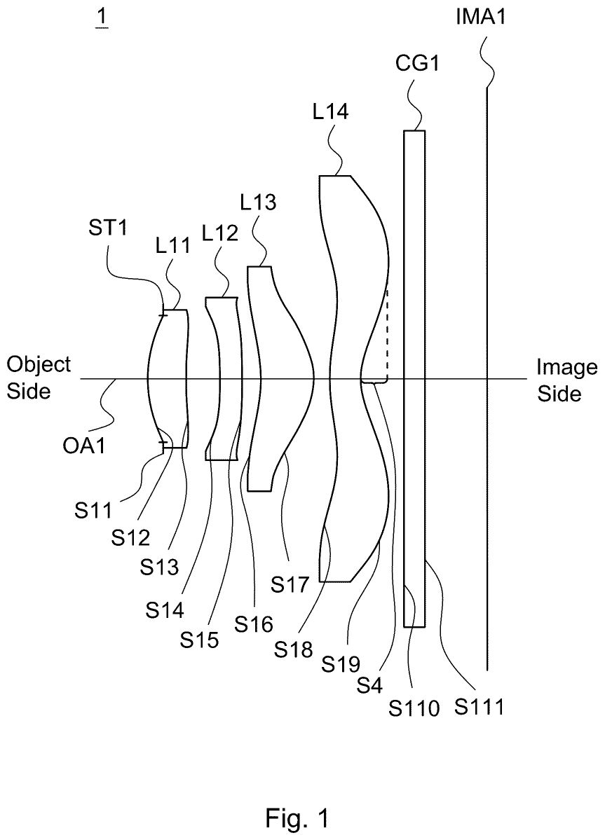

The present invention provides a lens assembly including a first lens, a second lens, a third lens, and a fourth lens. The first lens is with positive refractive power and includes a convex surface facing an object side. The second lens is with refractive power. The third lens is a meniscus lens with positive refractive power, and includes a concave surface facing the object side and a convex surface facing an image side. The fourth lens is with negative refractive power and includes a concave surface facing the image side. The first lens, the second lens, the third lens, and the fourth lens are arranged in order from the object side to the image side along an optical axis. The lens assembly satisfies at least one of following conditions: 2≤TTL/BFL≤2.9; 0.2 mm≤T2+T4≤0.5 mm; 0.5≤f3/f≤0.8; −2<R12/R11<4; 1.4≤D4/f≤1.7; −3≤D4/f4≤−1; 0.3≤D1/f1≤0.6; 0.6<S4/T4<1.4; 2<D4/BFL<6; 107 degrees/mm²<FOV/(f+TTL)2<111 degrees/mm²; 92 degrees/mm<FOV/D1<107 degrees/mm; wherein TTL is an interval from an object side surface of the first lens to an image plane along the optical axis, BFL is an interval from an image side surface of the fourth lens to the image plane along the optical axis, T2 is an interval from an object side surface of the second lens to an image side surface of the second lens, T4 is an interval from an object side surface of the fourth lens to the image side surface of the fourth lens, f is an effective focal length of the lens assembly, f1 is an effective focal length of the first lens, f3 is an effective focal length of the third lens, f4 is an effective focal length of the fourth lens, R₁₁ is a radius of curvature of the object side surface of the first lens, R₁₂ is a radius of curvature of an image side surface of the first lens, D1 is an optical effective diameter of the first lens, D4 is an optical effective diameter of the fourth lens, S4 (please refer the FIG. 1) is a depth from a center point of the image side surface of the fourth lens to a vertex of the image side surface of the fourth lens along the optical axis, and FOV is a field of view of the lens assembly. The basic operation of the lens assembly in the present invention can be achieved by satisfying the features of the exemplary embodiment without requiring other conditions.

Referring to Table 1, Table 2, Table 4, Table 5, Table 7, and Table 8 show optical specification in accordance with a first, second, and third embodiments of the invention respectively and Table 2, Table 5, and Table 8 show aspheric coefficient of each aspheric lens in Table 1, Table 4, and Table 7 respectively.

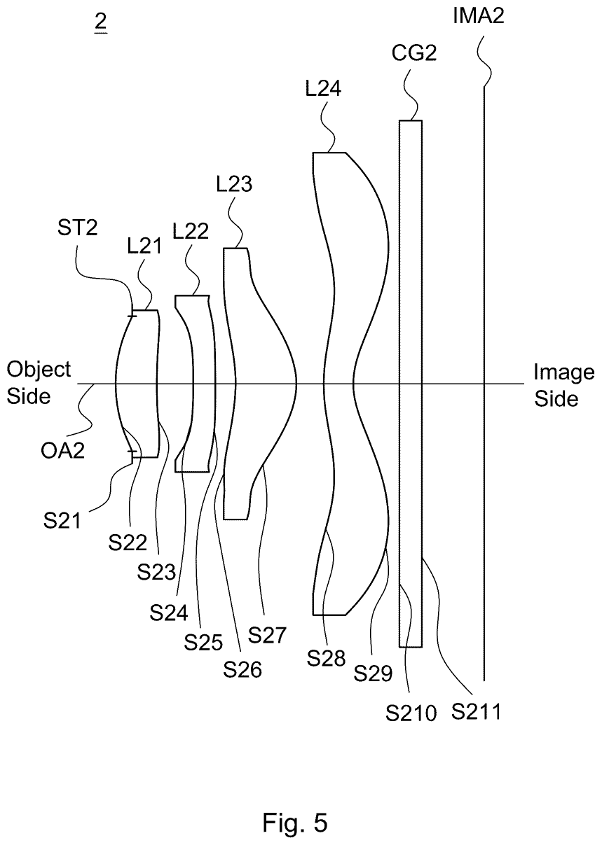

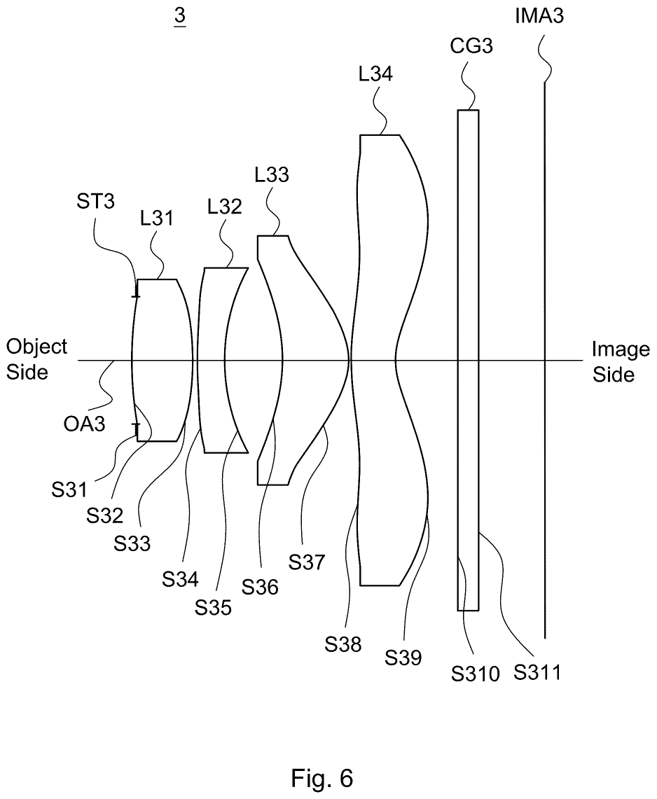

FIG. 1, FIG. 5, and FIG. 6 are lens layout diagrams of the lens assembly in accordance with the first, second, and third embodiments of the invention respectively. The first lens L11, L21, L31 are with positive refractive power and made of plastic material, wherein the object side surfaces S12, S22, S32 are convex surfaces, and the object side surfaces S12, S22, S32 and the image side surfaces S13, S23, S33 are aspheric surfaces.

The second lens L12, L22, L32 are meniscus lenses with negative refractive power and made of plastic material, wherein the object side surfaces S14, S24, S34 and the image side surfaces S15, S25, S35 are aspheric surfaces.

The third lens L13, L23, L33 are meniscus lenses with positive refractive power and made of plastic material, wherein the object side surfaces S16, S26, S36 are concave surfaces, the image side surfaces S17, S27, S37 are convex surfaces, and the object side surfaces S16, S26, S36 and the image side surfaces S17, S27, S37 are aspheric surfaces.

The fourth lens L14, L24, L34 are meniscus lenses with negative refractive power and made of plastic material, wherein the object side surfaces S18, S28, S38 are convex surfaces, the image side surfaces S19, S29, S39 are concave surfaces, and the object side surfaces S18, S28, S38 and the image side surfaces S19, S29, S39 are aspheric surface.

The above positive and negative refractive power structure helps to decrease total length of the lens assembly, decrease total height of the lens assembly, improve resolution, increase field of view, and correct aberrations. In addition, the lens assembly 1, 2 satisfy at least one of the following conditions (1)-(17), and the lens assembly 3 satisfy at least one of the following conditions (1)-(12):

$$2 \leq TTL / BFL \leq 2.9 ; \qquad ( 1 )$$

$$0.01 \leq SL / TTL \leq 0 \text{.06} ; \qquad ( 2 )$$

$$0.2 mm \leq T 2 + T 4 \leq 0.5 mm ; \qquad ( 3 )$$

$$0.5 \leq f 3 / f \leq 0.8 ; \qquad ( 4 )$$

$$- 2 < R 12 / R 11 < 4 ; \qquad ( 5 )$$

$$1.4 \leq D 4 / f \leq 1.7 ; \qquad ( 6 )$$

$$- 3 \leq D 4 / f 4 \leq - 1 ; \qquad ( 7 )$$

$$0.3 \leq D 1 / f 1 \leq 0.6 ; \qquad ( 8 )$$

$$0.6 < S 4 / T 4 < 1.4 \qquad ( 9 )$$

$$2 < D 4 / BFL < 6 ; \qquad ( 10 )$$

$$107 degrees / {mm}^{2} < F O V / {( f + TTL )}^{2} < 111 degrees / {mm}^{2} ; \qquad ( 11 )$$

$$92 degrees / mm < F O V / D 1 < 107 degrees / mm ; \qquad ( 12 )$$

$$- 180 < f 2 / T 2 < - 1 \; 05 ; \qquad ( 13 )$$

$$1 < Dr 12 r 21 / T 4 < 1.4 ; \qquad ( 14 )$$

$$40 mm < {( T T L )}^{2} / ( T 1 / 2 ) \leq 45 mm ; \qquad ( 15 )$$

$$5.5 < R 12 / R 42 < 7.3 ; \qquad ( 16 )$$

$$8.5 mm < {( R 12 )}^{2} / BFL < 12.5 mm \qquad ( 17 )$$

wherein TTL is an interval from the object side surfaces S12, S22, S32 of the first lenses L11, L21, L31 to the image planes IMA1, IMA2, IMA3 along the optical axes OA1, OA2, OA3 respectively for the first to third embodiments, BFL is an interval from the image side surfaces S19, S29, S39 of the fourth lenses L14, L24, L34 to the image planes IMA1, IMA2, IMA3 along the optical axes OA1, OA2, OA3 respectively for the first to third embodiments, SL is an interval from the stop ST1, ST2, ST3 to the object side surface S12, S22, S32 of the first lenses L11, L21, L31 along the optical axis OA1, OA2, OA3 respectively for the first to third embodiment, T2 is an interval from the object side surfaces S14, S24, S34 of the second lenses L12, L22, L32 to the image side surfaces S15, S25, S35 of the second lenses L12, L22, L32 along the optical axes OA1, OA2, OA3 respectively for the first to third embodiments, T4 is an interval from the object side surfaces S18, S28, S38 of the fourth lenses L14, L24, L34 to the image side surfaces S19, S29, S39 of the fourth lenses L14, L24, L34 along the optical axes OA1, OA2, OA3 respectively for the first to third embodiments, f is an effective focal length of the lens assemblies 1, 2, 3 respectively for the first to third embodiments, f1 is an effective focal length of the first lenses L11, L21, L31 respectively for the first to third embodiments, f3 is an effective focal length of the third lenses L13, L23, L33 respectively for the first to third embodiments, f4 is an effective focal length of the fourth lenses L14, L24, L34 respectively for the first to third embodiments, R₁₁ is a radius of curvature of the object side surface S12, S22, S32 of the first lenses L11, L21, L31 respectively for the first to third embodiments, R₁₂ is a radius of curvature of the image side surface S13, S23, S33 of the first lenses L11, L21, L31 respectively for the first to third embodiments, D1 is an optical effective diameter of the first lenses L11, L21, L31 respectively for the first to third embodiments, D4 is an optical effective diameter of the fourth lenses L14, L24, L34 respectively for the first to third embodiments, S4 is a depth from a center point of the image side surface S19, S29, S39 of the fourth lenses L14, L24, L34 to the vertex of the image side surface S19, S29, S39 of the fourth lenses L14, L24, L34 along the optical axes OA1, OA2, OA3 respectively for the first to third embodiments, FOV is a field of view of the lens assemblies 1, 2, 3 respectively for the first to third embodiments, f2 is an effective focal length of the second lenses L12, L22, L32 respectively for the first to third embodiments, T1 is an interval from the object side surfaces S12, S22, S32 of the first lenses L11, L21, L31 to the image side surfaces S13, S23, S33 of the first lenses L11, L21, L31 along the optical axes OA1, OA2, OA3 respectively for the first to third embodiments, R₄₂ is a radius of curvature of the image side surface S19, S29, S39 of the fourth lens L14, L24, L34 respectively for the first to third embodiments, and Dr12r21 is an interval from the image side surfaces S13, S23, S33 of the first lenses L11, L21, L31 to the object side surfaces S14, S24, S34 of the second lenses L12, L22, L32 along the optical axes OA1, OA2, OA3 respectively for the first to third embodiments. With the lens assemblies 1, 2, 3 satisfying at least one of the above conditions, the total length of lens assembly can be effectively decreased, the total height of lens assembly can be effectively decreased, the resolution can be effectively increased, the field of view can be effectively increased, and the aberration can be effectively corrected. The preferred embodiment of the present invention can be achieved when the lens assembly satisfies at least one of the conditions (1)-(17).

When the condition (1): 2≤TTL/BFL≤2.9 or the condition (2): 0.01≤SL/TTL≤0.06 or the condition (3): 0.2 mm≤T2+T4≤0.5 mm is satisfied, the total height of the lens assembly can be effectively decreased. When the condition (4): 0.5≤f3/f≤0.8 is satisfied, the aberration can be effectively corrected and the resolution can be effectively increased. When the condition (5): −2<R12/R11<4 is satisfied, the curvature radius of the first lens can be effectively controlled and the distortion can be corrected. When the condition (6): 1.4≤D4/f≤1.7 or the condition (7): −3≤D4/f4≤−1 is satisfied, the volume of lens assembly can be effectively decreased. When the condition (8): 0.3≤D1/f1≤0.6 or the condition (9): 0.6<S4/T4<1.4 is satisfied, the aberration can be effectively corrected. When the condition (10): 2<D4/BFL<6 is satisfied, the space utilization of lens assembly can be improved and make the configuration more compact. When the condition (11): 107 degrees/mm²<FOV/(f+TTL)²<111 degrees/mm² or the condition (12): 92 degrees/mm<FOV/D1<107 degrees/mm is satisfied, it helps to facilitate the convenience of assembly of lens assembly. When the condition (13): −180<f2/T2<−105 is satisfied, conducive to chromatic aberration correction of lens assembly. When the condition (14): 1<Dr12r21/T4<1.4 or the condition (15): 40 mm<(TTL)²/(T1/2)≤45 mm is satisfied, it can make the lens configuration of lens assembly more balanced. When the condition (16): 5.5<R12/R42<7.3 or the condition (17): 8.5 mm<(R12)²/BFL<12.5 mm is satisfied, the astigmatism of lens assembly can be corrected.

A detailed description of a lens assembly in accordance with a first embodiment of the invention is as follows. Referring to FIG. 1, the lens assembly 1 includes a stop ST1, a first lens L11, a second lens L12, a third lens L13, a fourth lens L14, and a cover glass CG1. The stop ST1, the first lens L11, the second lens L12, the third lens L13, the fourth lens L14 and the cover glass CG1 in order from an object side to an image side along an optical axis OA1. In operation, an image of light rays from the object side is formed at an image plane IMA1.

According to the foregoing, wherein: the first lens L11 is a meniscus lens, wherein the image side surface S13 is a concave surface; the object side surface S14 of the second lens L12 is a concave surface and the image side surface S15 of the second lens L12 is a convex surface; both of the object side surface S110 and image side surface S111 of the cover glass CG1 are plane surfaces. With the above design of the lenses and stop ST1 and at least any one of the conditions (1)-(17) satisfied, the lens assembly 1 can have an effective decreased the total length, an effective decreased the total height, an effective increased resolution, an effective increased field of view, and is capable of an effective corrected aberration.

Table 1 shows the optical specification of the lens assembly 1 in FIG. 1.

TABLE 1
Effective Focal Length = 1.787 mm F-number = 2.0
Total Lens Length = 2.351 mm Field of View = 92.520 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S11 | ∞ | −0.107 | | | | ST1 |
| S12 | 0.901 | 0.266 | 1.545 | 56.0 | 2.235 | L11 |
| S13 | 3.079 | 0.235 | | | | |
| S14 | −3.222 | 0.154 | 1.661 | 20.4 | −26.720 | L12 |
| S15 | −4.009 | 0.129 | | | | |
| S16 | −0.953 | 0.367 | 1.535 | 56.1 | 1.317 | L13 |
| S17 | −0.461 | 0.111 | | | | |
| S18 | 1.219 | 0.215 | 1.535 | 56.1 | −1.480 | L14 |
| S19 | 0.452 | 0.300 | | | | |
| S110 | ∞ | 0.145 | 1.517 | 64.2 | | CG1 |
| S111 | ∞ | 0.430 | | | | |

The aspheric surface sag z of each aspheric lens in table 1 can be calculated by the following formula:

$$z = {ch}^{2} / \{ 1 + {[ 1 ( k + 1 ) {c}^{2} {h}^{2} ]}^{1 / 2} \} + {Ah}^{4} + {Bh}^{6} + {Ch}^{8} + {Dh}^{10} + {Eh}^{12} + {Fh}^{14} + {Gh}^{9}$$

where c is curvature, h is the vertical distance from the lens surface to the optical axis, k is conic constant and A, B, C, D, E, F, and G are aspheric coefficients. In the first embodiment, the conic constant k and the aspheric coefficients A, B, C, D, E, F, G of each aspheric surface are shown in Table 2.

TABLE 2

| Surface | | A | B | C | |
|---|---|---|---|---|---|
| Number | k | E | F | G | D |
| S12 | 2.161E+00 | −6.7404E−01 | 5.3240E+00 | −7.9085E+01 | 4.2947E+02 |
| | | −1.1121E+03 | 4.4220E−01 | 1.8211E+03 | |
| S13 | 2.675E+01 | −1.3098E−01 | −5.9481E+00 | 3.6600E+01 | −1.6716E+01 |
| | | −1.7765E+03 | 1.0232E+04 | −1.8308E+04 | |
| S14 | −4.302E+01 | −5.6620E−01 | −9.6489E+00 | 5.0212E+01 | −8.9008E+01 |
| | | −8.8572E+02 | 7.0083E+03 | −1.3166E+04 | |
| S15 | 0.000E+00 | 5.7784E−01 | −6.1457E+00 | 1.8615E+01 | −4.0634E+00 |
| | | −1.2399E+02 | 6.6126E+02 | −8.9138E+02 | |
| S16 | −4.916E+00 | 9.2599E−01 | −5.9532E−01 | −1.0311E+01 | 3.1253E+01 |
| | | 2.6499E+00 | −1.0291E+02 | 9.3834E+01 | |
| S17 | −2.421E+00 | 2.6919E−01 | −1.8847E+00 | 5.7926E+00 | −4.0948E−01 |
| | | −1.1082E+01 | 7.5010E+00 | 2.3085E−01 | |
| S18 | −5.397E−01 | −1.0317E+00 | 7.7154E−01 | −2.6877E−01 | 6.9097E−02 |
| | | −3.2935E−02 | 9.6798E−03 | −6.3465E−04 | |
| S19 | −4.564E+00 | −5.2234E−01 | 6.0524E−01 | −6.0013E−01 | 4.1380E−01 |
| | | −1.8692E−01 | 4.8114E−02 | −5.0695E−03 | |

Table 3 shows the parameters and condition values for conditions (1)-(17) in accordance with the first embodiment of the invention. It can be seen from Table 3 that the lens assembly 1 of the first embodiment satisfies the conditions (1)-(17).

TABLE 3

| | | | | | |
|---|---|---|---|---|---|
| BFL | 0.875 mm | SL | 0.107 mm | T2 | 0.154 mm |
| T4 | 0.215 mm | D4 | 2.900 mm | D1 | 0.876 mm |
| S4 | 0.193 mm | Dr12r21 | 0.235 mm | T1 | 0.266 mm |
| TTL/BFL | 2.687 | SL/TTL | 0.046 | T2 + T4 | 0.369 mm |
| f3/f | 0.737 | R12/R11 | 3.417 | D4/f | 1.623 |
| D4/f4 | −1.959 | D1/f1 | 0.392 | S4/T4 | 0.898 |
| D4/BFL | 3.314 | FOV/ | 109.643 | FOV/D1 | 105.616 |
| | | (f + TTL)² | degrees/mm² | | degrees/ |
| | | | | | mm |
| f2/T2 | −173.506 | Dr12r21/ | 1.093 | (TTL)²/ | 41.56 mm |
| | | T4 | | (T1/2) | |
| R12/R42 | 6.812 | (R12)²/ | 10.835 mm | | |
| | | BFL | | | |

The preferred embodiment of the present invention can be achieved when the lens assembly 1 satisfies the conditions (1)-(17), refractive power distribution, and surface shape.

The lens assembly 1 can meet the basic operation requirements when it is modified to only satisfies at least one of the conditions (1)-(17); the first lens having positive refractive power, a convex surface facing the object side; the second lens having refractive power; the third lens having positive refractive power, a concave surface facing the object side, and a convex surface facing the image side; the fourth lens having negative refractive power, a concave surface facing the image side; and does not need other additional features and conditions.

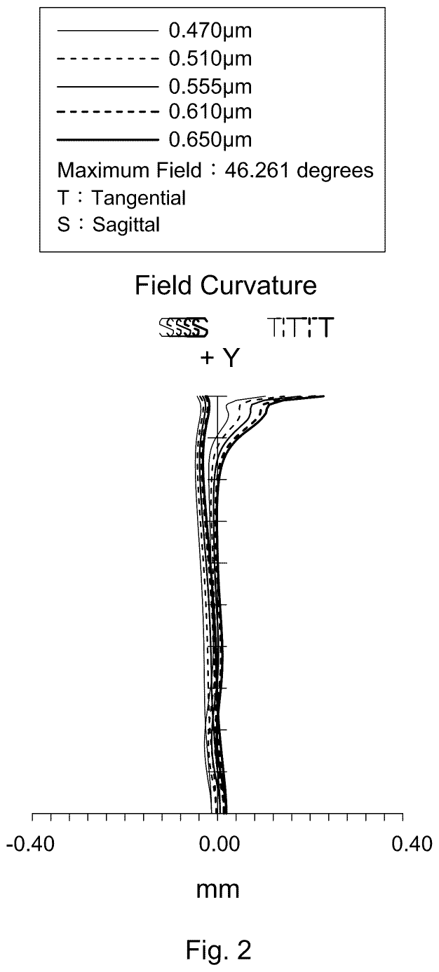

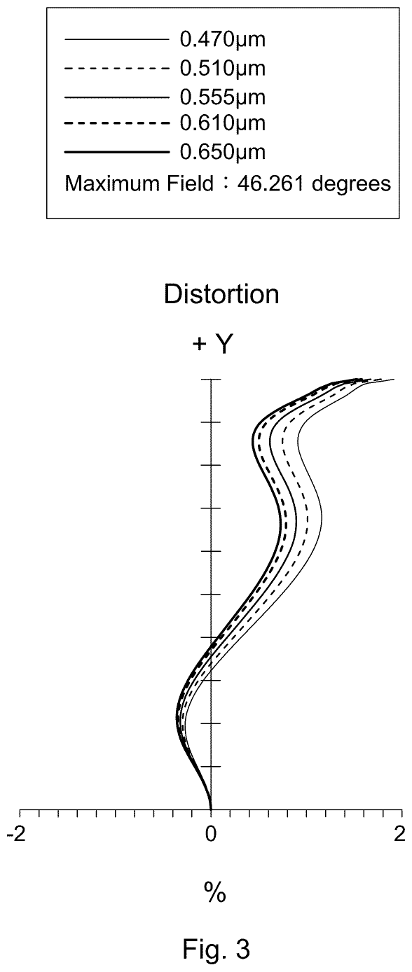

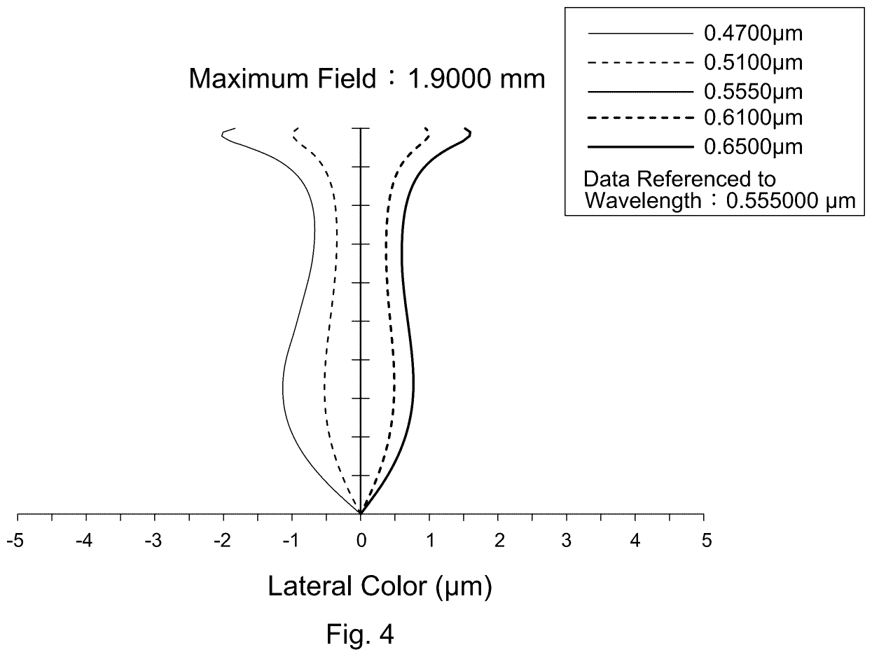

By the above arrangements of the lenses and stop ST1, the lens assembly 1 of the first embodiment can meet the requirements of optical performance. It can be seen from FIG. 2 that the field curvature of tangential direction and sagittal direction in the lens assembly 1 of the first embodiment ranges from −0.08 mm to 0.24 mm. It can be seen from FIG. 3 that the distortion in the lens assembly 1 of the first embodiment ranges from 0.4% to 2%. It can be seen from FIG. 4 that the lateral color in the lens assembly 1 of the first embodiment ranges from −2.5 μm to 2 μm. It is obvious that the field curvature, the distortion and the lateral color of the lens assembly 1 of the first embodiment can be corrected effectively. Therefore, the lens assembly 1 of the first embodiment is capable of good optical performance.

Referring to FIG. 5, FIG. 5 is a lens layout diagram of a lens assembly in accordance with a second embodiment of the invention. The lens assembly 2 includes a stop ST2, a first lens L21, a second lens L22, a third lens L23, a fourth lens L24, and a cover glass CG2. The stop ST2, the first lens L21, the second lens L22, the third lens L23, the fourth lens L24 and the cover glass CG2 in order from an object side to an image side along an optical axis OA2. In operation, an image of light rays from the object side is formed at an image plane IMA2.

According to the foregoing, wherein: the first lens L21 is a meniscus lens, wherein the image side surface S23 is a concave surface; the object side surface S24 of the second lens L22 is a concave surface and the image side surface S25 of the second lens L22 is a convex surface; both of the object side surface S210 and image side surface S211 of the cover glass CG2 are plane surfaces. With the above design of the lenses and stop ST2 and at least any one of the conditions (1)-(17) satisfied, the lens assembly 2 can have an effective decreased the total length, an effective decreased the total height, an effective increased resolution, an effective increased field of view, and is capable of an effective corrected aberration.

Table 4 shows the optical specification of the lens assembly 2 in FIG. 5.

TABLE 4
Effective Focal Length = 1.785 mm F-number = 2.0
Total Lens Length = 2.400 mm Field of View = 92.000 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S21 | ∞ | −0.108 | | | | ST2 |
| S22 | 0.903 | 0.268 | 1.545 | 56.0 | 2.325 | L21 |
| S23 | 2.798 | 0.237 | | | | |
| S24 | −4.096 | 0.144 | 1.661 | 20.4 | −17.194 | L22 |
| S25 | −6.407 | 0.132 | | | | |
| S26 | −1.001 | 0.395 | 1.535 | 56.1 | 1.364 | L23 |
| S27 | −0.481 | 0.178 | | | | |
| S28 | 1.116 | 0.193 | 1.535 | 56.1 | −1.632 | L24 |
| S29 | 0.461 | 0.440 | | | | |
| S210 | ∞ | 0.145 | 1.517 | 64.2 | | CG2 |
| S211 | ∞ | 0.268 | | | | |

The definition of aspheric surface sag z of each aspheric lens in table 4 is the same as that of in Table 1, and is not described here again. In the second embodiment, the conic constant k and the aspheric coefficients A, B, C, D, E, F, G of each aspheric surface are shown in Table 5.

TABLE 5

| Surface | | A | B | C | |
|---|---|---|---|---|---|
| Number | k | E | F | G | D |
| S22 | 2.119E+00 | −6.1486E−01 | 4.7005E+00 | −7.1136E+01 | 3.7939E+02 |
| | | −8.5104E+02 | −8.0195E+02 | 2.7429E+03 | |
| S23 | 3.012E+01 | −1.6894E−01 | −5.6261E+00 | 3.1612E+01 | −4.9279E+01 |
| | | −1.3722E+03 | 8.6174E+03 | −1.6693E+04 | |
| S24 | −7.374E+01 | −6.2893E−01 | −1.0426E+01 | 4.2341E+01 | −7.3784E+01 |
| | | −7.1272E+02 | 5.5468E+03 | −9.8680E+03 | |
| S25 | 0.000E+00 | 4.6398E−01 | −6.8621E+00 | 1.5162E+01 | 7.3476E−01 |
| | | −9.2062E+01 | 4.7556E+02 | −5.9971E+02 | |
| S26 | −3.784E+00 | 1.0117E+00 | −5.5755E−01 | −9.4208E+00 | 2.6822E+01 |
| | | 3.1270E+00 | −7.9639E+01 | 6.6956E+01 | |
| S27 | −2.143E+00 | 3.0250E−01 | −2.0631E+00 | 5.5802E+00 | 2.6748E−01 |
| | | −9.3801E+00 | 4.4176E+00 | 1.2552E+00 | |
| S28 | −6.182E−01 | −9.5975E−01 | 6.5925E−01 | −2.3448E−01 | 6.1222E−02 |
| | | −2.4284E−02 | 8.2241E−03 | −1.2729E−03 | |
| S29 | −3.849E+00 | −4.8707E−01 | 5.4864E−01 | −5.2872E−01 | 3.6243E−01 |
| | | −1.6358E−01 | 4.2582E−02 | −4.7679E−03 | |

Table 6 shows the parameters and condition values for conditions (1)-(17) in accordance with the second embodiment of the invention. It can be seen from Table 6 that the lens assembly 2 of the second embodiment satisfies the conditions (1)-(17).

TABLE 6

| | | | | | |
|---|---|---|---|---|---|
| BFL | 0.853 mm | SL | 0.108 mm | T2 | 0.144 mm |
| T4 | 0.193 mm | D4 | 3.000 mm | D1 | 0.875 mm |
| S4 | 0.229 mm | Dr12r21 | 0.237 mm | T1 | 0.268 mm |
| TTL/BFL | 2.814 | SL/TTL | 0.045 | T2 + T4 | 0.337 mm |
| f3/f | 0.764 | R12/R11 | 3.099 | D4/f | 1.681 |
| D4/f4 | −1.838 | D1/f1 | 0.376 | S4/T4 | 1.187 |
| D4/BFL | 3.517 | FOV/ | 109.514 | FOV/D1 | 105.143 |
| | | (f + TTL)² | degrees/mm² | | degrees/ |
| | | | | | mm |
| f2/T2 | −119.402 | Dr12r21/ | 1.228 | (TTL)²/ | 42.99 mm |
| | | T4 | | (T1/2) | |
| R12/R42 | 6.069 | (R12)²/ | 9.178 mm | | |
| | | BFL | | | |

The preferred embodiment of the present invention can be achieved when the lens assembly 2 satisfies the conditions (1)-(17), refractive power distribution, and surface shape.

The lens assembly 2 can meet the basic operation requirements when it is modified to only satisfies at least one of the conditions (1)-(17); the first lens having positive refractive power, a convex surface facing the object side; the second lens having refractive power; the third lens having positive refractive power, a concave surface facing the object side, and a convex surface facing the image side; the fourth lens having negative refractive power, a concave surface facing the image side; and does not need other additional features and conditions.

Referring to FIG. 6, FIG. 6 is a lens layout diagram of a lens assembly in accordance with a third embodiment of the invention. The lens assembly 3 includes a stop ST3, a first lens L31, a second lens L32, a third lens L33, a fourth lens L34, and a cover glass CG3. The stop ST3, the first lens L31, the second lens L32, the third lens L33, the fourth lens L34 and the cover glass CG3 in order from an object side to an image side along an optical axis OA3. In operation, an image of light rays from the object side is formed at an image plane IMA3.

According to the foregoing, wherein: the first lens L31 is a biconvex lens, wherein the image side surface S33 is a convex surface; the object side surface S34 of the second lens L32 is a convex surface and the image side surface S35 of the second lens L32 is a concave surface; both of the object side surface S310 and image side surface S311 of the cover glass CG3 are plane surfaces. With the above design of the lenses and stop ST3 and at least any one of the conditions (1)-(12) satisfied, the lens assembly 3 can have an effective decreased the total length, an effective decreased the total height, an effective increased resolution, an effective increased field of view, and is capable of an effective corrected aberration.

Table 7 shows the optical specification of the lens assembly 3 in FIG. 6.

TABLE 7
Effective Focal Length = 2.111 mm F-number = 2.0
Total Lens Length = 2.848 mm Field of View = 83.900 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S31 | ∞ | −0.037 | | | | ST3 |
| S32 | 1.627 | 0.428 | 1.545 | 56.0 | 1.786 | L31 |
| S33 | −2.216 | 0.033 | | | | |
| S34 | 3.574 | 0.187 | 1.651 | 21.5 | −3.363 | L32 |
| S35 | 1.338 | 0.400 | | | | |
| S36 | −1.169 | 0.454 | 1.545 | 56.0 | 1.087 | L33 |
| S37 | −0.448 | 0.017 | | | | |
| S38 | 1.867 | 0.304 | 1.545 | 56.0 | −1.188 | L34 |
| S39 | 0.454 | 0.426 | | | | |
| S310 | ∞ | 0.145 | 1.517 | 64.2 | | CG3 |
| S311 | ∞ | 0.455 | | | | |

The definition of aspheric surface sag z of each aspheric lens in table 7 is the same as that of in Table 1, and is not described here again. In the third embodiment, the conic constant k and the aspheric coefficients A, B, C, D, E, F, G of each aspheric surface are shown in Table 8.

TABLE 8

| Surface | | A | B | C | |
|---|---|---|---|---|---|
| Number | k | E | F | G | D |
| S32 | 1.912E+00 | −2.8861E−01 | −1.3169E−01 | −2.7297E+00 | −1.8947E+00 |
| | | 2.4635E+01 | −1.1315E+02 | 3.5606E+02 | |
| S33 | 0.000E+00 | −3.2542E−01 | −1.4807E+00 | 6.6961E+00 | −2.1543E+00 |
| | | −5.0189E+01 | 1.7124E+02 | −2.7767E+02 | |
| S34 | 0.000E+00 | −1.7561E−01 | −1.4766E+00 | 5.4945E+00 | 9.8136E+00 |
| | | −4.1068E+00 | −1.4475E+02 | 2.0096E+02 | |
| S35 | −5.841E+00 | 3.2881E−01 | −1.2374E+00 | 1.4579E+00 | 7.7699E+00 |
| | | −4.1036E+00 | −3.7775E+01 | 4.0355E+01 | |
| S36 | 6.873E−01 | 3.0107E−01 | 3.2783E−01 | −1.2590E+00 | 1.8778E+00 |
| | | −8.4180E+00 | 3.3328E+01 | −3.5815E+01 | |
| S37 | −3.871E+00 | −8.1663E−01 | 2.2784E+00 | −4.0446E+00 | 2.9085E+00 |
| | | 2.8097E+00 | −3.1948E+00 | −2.9306E−01 | |
| S38 | 0.000E+00 | −4.2172E−01 | 2.0054E−01 | −2.7909E−02 | 2.1372E−02 |
| | | −2.6966E−02 | 1.0314E−02 | −1.3139E−03 | |
| S39 | −5.713E+00 | −2.6547E−01 | 2.1337E−01 | −1.5602E−01 | 7.1986E−02 |
| | | −1.9430E−02 | 3.2121E−03 | −3.0390E−04 | |

Table 9 shows the parameters and condition values for conditions (1)-(12) in accordance with the third embodiment of the invention. It can be seen from Table 9 that the lens assembly 3 of the third embodiment satisfies the conditions (1)-(12).

TABLE 9

| | | | | | |
|---|---|---|---|---|---|
| BFL | 1.026 mm | SL | 0.037 mm | T2 | 0.187 mm |
| T4 | 0.304 mm | D4 | 3.093 mm | D1 | 0.892 mm |
| S4 | 0.223 mm | | | | |
| TTL/BFL | 2.776 | SL/TTL | 0.013 | T2 + T4 | 0.491 mm |
| f3/f | 0.515 | R12/R11 | −1.362 | D4/f | 1.465 |
| D4/f4 | −2.604 | D1/f1 | 0.500 | S4/T4 | 0.734 |
| D4/BFL | 3.015 | FOV/ | 108.492 | FOV/D1 | 94.058 |
| | | (f + TTL)² | degrees/mm² | | degrees/ |
| | | | | | mm |

The preferred embodiment of the present invention can be achieved when the lens assembly 3 satisfies the conditions (1)-(12), refractive power distribution, and surface shape.

The lens assembly 3 can meet the basic operation requirements when it is modified to only satisfies at least one of the conditions (1)-(12); the first lens having positive refractive power, a convex surface facing the object side; the second lens having refractive power; the third lens having positive refractive power, a concave surface facing the object side, and a convex surface facing the image side; the fourth lens having negative refractive power, a concave surface facing the image side; and does not need other additional features and conditions.

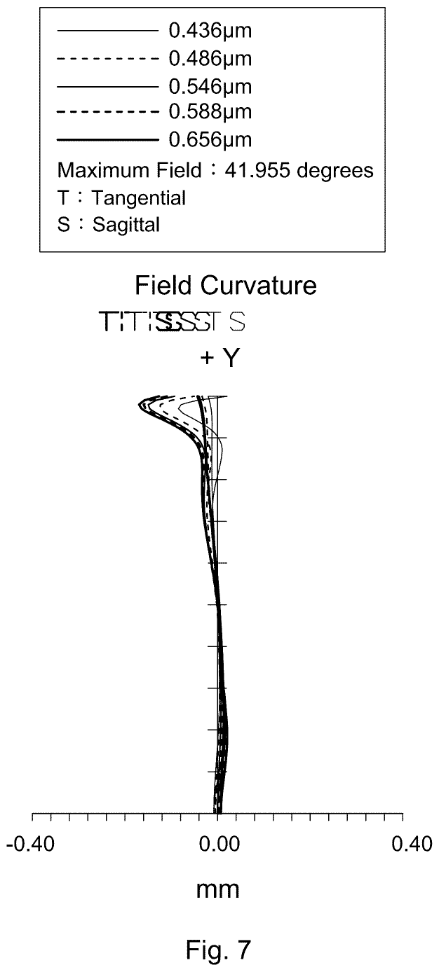

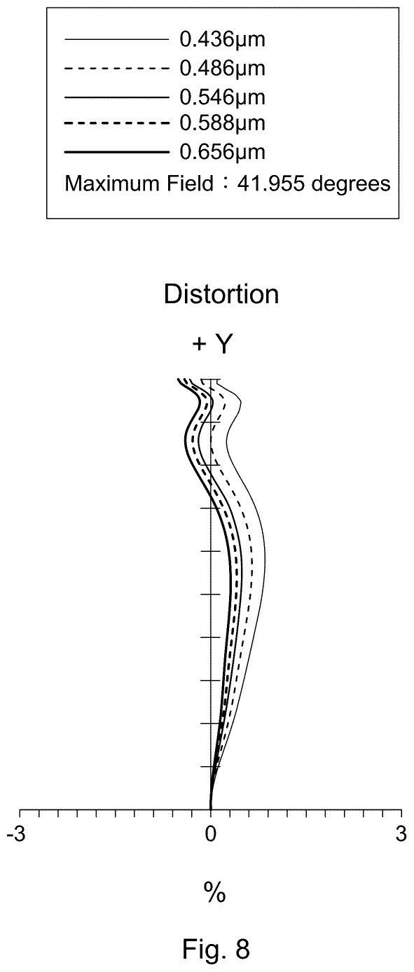

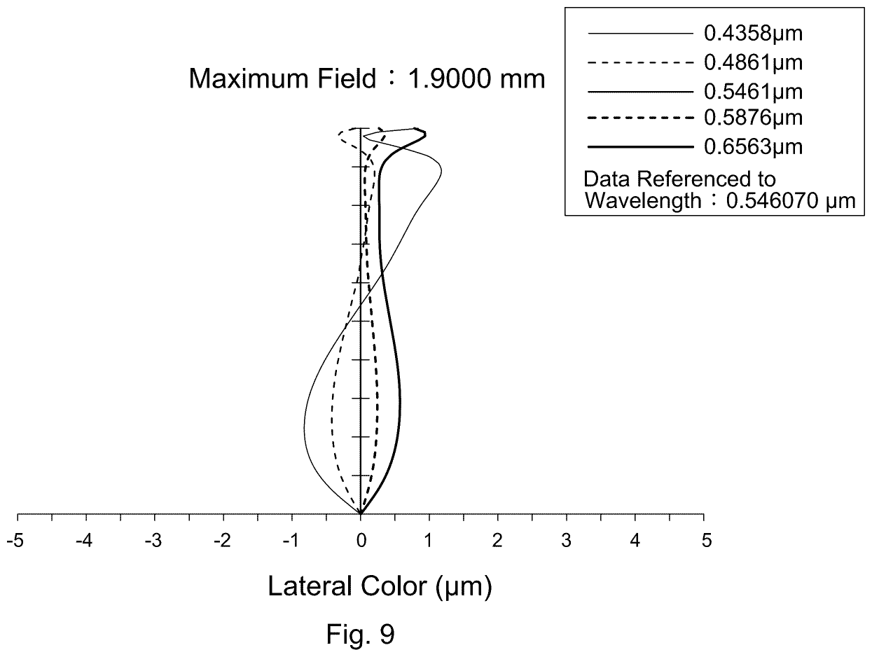

By the above arrangements of the lenses and stop ST3, the lens assembly 3 of the third embodiment can meet the requirements of optical performance. It can be seen from FIG. 7 that the field curvature of tangential direction and sagittal direction in the lens assembly 3 of the third embodiment ranges from −0.20 mm to 0.04 mm. It can be seen from FIG. 8 that the distortion in the lens assembly 3 of the third embodiment ranges from −0.6% to 0.9%. It can be seen from FIG. 9 that the lateral color in the lens assembly 3 of the third embodiment ranges from −1.0 μm to 1.5 μm. It is obvious that the field curvature, the distortion and the lateral color of the lens assembly 3 of the third embodiment can be corrected effectively. Therefore, the lens assembly 3 of the third embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is with positive refractive power and comprises a convex surface facing an object side;
a second lens which is with refractive power;
a third lens which is a meniscus lens with positive refractive power and comprises a concave surface facing the object side, and a convex surface facing an image side; and
a fourth lens which is with negative refractive power and comprises a concave surface facing the image side;
wherein the first lens, the second lens, the third lens, and the fourth lens are arranged in order from the object side to the image side along an optical axis;
wherein the lens assembly satisfies at least one of following conditions:
$$2 \leq TTL / BFL \leq 2.9 ;$$
$$0.2 \leq T2 + T 4 \leq 0.5 mm ;$$
$$0.5 \leq f 3 / f \leq 0.8 ;$$
$$- 2 < R 12 / R 11 < 4 ;$$
$$1.4 \leq D 4 / f \leq 1.7 ;$$
$$- 3 \leq D 4 / f 4 \leq - 1 ;$$
$$0. 3 \leq D 1 / f 1 \leq 0.6 ;$$
$$0.6 < S 4 / T 4 < 1.4 ;$$
$$2 < D 4 / BFL < 6 ;$$
$$107 degrees / {mm}^{2} < F O V / {( f + T T L )}^{2} < 111 degrees / {mm}^{2} ;$$
$$92 degrees / mm < F O V / D 1 < 107 degrees / mm ;$$
wherein TTL is an interval from an object side surface of the first lens to an image plane along the optical axis, BFL is an interval from an image side surface of the fourth lens to the image plane along the optical axis, T2 is an interval from an object side surface of the second lens to an image side surface of the second lens, T4 is an interval from an object side surface of the fourth lens to the image side surface of the fourth lens, f is an effective focal length of the lens assembly, f1 is an effective focal length of the first lens, f3 is an effective focal length of the third lens, f4 is an effective focal length of the fourth lens, R₁₁ is a radius of curvature of the object side surface of the first lens, R₁₂ is a radius of curvature of an image side surface of the first lens, D1 is an optical effective diameter of the first lens, D4 is an optical effective diameter of the fourth lens, S4 is a depth from a center point of the image side surface of the fourth lens to a vertex of the image side surface of the fourth lens along the optical axis, and FOV is a field of view of the lens assembly.

2. The lens assembly as claimed in claim 1, wherein the second lens is a meniscus lens with negative refractive power.

3. The lens assembly as claimed in claim 2, wherein the second lens comprises a concave surface facing the object side and a convex surface facing the image side.

4. The lens assembly as claimed in claim 3, wherein the first lens is a meniscus lens and further comprises a concave surface facing the image side.

5. The lens assembly as claimed in claim 4, wherein the fourth lens is a meniscus lens and further comprises a convex surface facing the object side.

6. The lens assembly as claimed in claim 1, wherein the lens assembly satisfies at least one of the following conditions:
$$- 180 < f 2 / T 2 < - 105 ;$$
$$40 mm < {( TTL )}^{2} / ( T 1 / 2 ) \leq 45 mm ;$$
$$5.5 < R 12 / R 42 < 7.3 ;$$
$$8.5 mm < {( R 12 )}^{2} / BFL < 12.5 mm ;$$
wherein f2 is an effective focal length of the second lens, T1 is an interval from the object side surface of the first lens to the image side surface of the first lens, T2 is an interval from the object side surface of the second lens to the image side surface of the second lens, TTL is an interval from the object side surface of the first lens to the image plane along the optical axis, BFL is an interval from the image side surface of the fourth lens to the image plane along the optical axis, R₁₂ is a radius of curvature of the image side surface of the first lens, and R₄₂ is a radius of curvature of the image side surface of the fourth lens.

7. The lens assembly as claimed in claim 1, further comprising a stop disposed between the object side and the first lens;
wherein the lens assembly satisfies at least one of the following conditions:
$$0.01 \leq SL / TTL \leq 0.06 ;$$
$$1 < Dr 12 r 21 / T 4 < 1.4 ;$$
wherein SL is an interval from the stop to the object side surface of the first lens along the optical axis, TTL is an interval from the object side surface of the first lens to the image plane along the optical axis, Dr12r21 is an interval from the image side surface of the first lens to the object side surface of the second lens along the optical axis, and T4 is an interval from the object side surface of the fourth lens to the image side surface of the fourth lens.

8. The lens assembly as claimed in claim 2, wherein the second lens comprises a convex surface facing the object side and a concave surface facing the image side.

9. The lens assembly as claimed in claim 8, wherein the first lens is a biconvex lens and further comprises another convex surface facing the image side.

10. The lens assembly as claimed in claim 9, wherein the fourth lens is a meniscus lens and further comprises a convex surface facing the object side.

11. The lens assembly as claimed in claim 8, further comprising a stop disposed between the object side and the first lens;
wherein the lens assembly satisfies at least one of the following conditions:
$$0.01 \leq SL / TTL \leq 0 \text{.06} ;$$
wherein SL is an interval from the stop to the object side surface of the first lens along the optical axis, and TTL is an interval from the object side surface of the first lens to the image plane along the optical axis.

12. The lens assembly as claimed in claim 3, wherein the lens assembly satisfies at least one of the following conditions:
$$0.01 \leq SL / TTL \leq 0.06 ;$$
$$- 180 < f 2 / T 2 < - 1 \; 05 ;$$
$$1 < Dr 12 r 21 / T 4 < 1.4 ;$$
$$40 mm < {( TTL )}^{2} / ( T 1 / 2 ) \leq 45 mm ;$$
$$5.5 < R 12 / R 42 < 7.3 ;$$
$$8.5 mm < {( R 12 )}^{2} / BFL < 12.5 mm ;$$
wherein SL is an interval from the stop to the object side surface of the first lens along the optical axis, f2 is an effective focal length of the second lens, T1 is an interval from the object side surface of the first lens to the image side surface of the first lens, T2 is an interval from the object side surface of the second lens to the image side surface of the second lens, T4 is an interval from the object side surface of the fourth lens to the image side surface of the fourth lens, TTL is an interval from the object side surface of the first lens to the image plane along the optical axis, BFL is an interval from the image side surface of the fourth lens to the image plane along the optical axis, R₁₂ is a radius of curvature of the image side surface of the first lens, R₄₂ is a radius of curvature of the image side surface of the fourth lens, and Dr12r21 is an interval from the image side surface of the first lens to the object side surface of the second lens along the optical axis.
